(19) United States
(12) Patent Application Publication
(10) Pub. No.: US 2017/0116379 A1
(43) Pub. Date: Apr. 27, 2017

(54) SYSTEMS AND METHODS FOR DYNAMICALLY GENERATED GENOMIC DECISION SUPPORT FOR INDIVIDUALIZED MEDICAL TREATMENT

(71) Applicant: Aetna Inc., Hartford, CT (US)

(72) Inventors: Adam Scott, Needham, MA (US); Henry George Wei, Larchmont, NY (US); Michael Palmer, Boston, MA (US)

(21) Appl. No.: 15/081,250

(22) Filed: Mar. 25, 2016

Related U.S. Application Data
(60) Provisional application No. 62/246,429, filed on Oct. 26, 2015.

(51) Int. Cl. G06F 19/00; G06F 19/18

(52) U.S. Cl. CPC G06F 19/345; G06F 19/18

(57) ABSTRACT

Optimization of therapeutic outcomes is disclosed. By analyzing molecular genomic sequence data from an individual relative to a pre-defined knowledge base as well as dynamically generated analyses from comparison to a set of other individuals and molecular genomic sequence data of those other individuals along with their therapeutic history and clinical outcome, medication selection for optimum therapeutic outcomes is achieved. The system determines likelihoods of the desired clinical outcome and adverse event profile derived from both the predefined knowledge base along with the dynamic analysis of large-scale population data (e.g., 1 million clinical profiles including linked genomes or some appropriate sample size of clinical profiles with linked genomes sufficient for statistically-powered analyses), and provides a set of recommendations and alternatives for a clinician based on the patient's profile. In certain instances, the system devises a therapeutic strategy of explicit absence of medical therapy for the purposes of cohort analysis.

### CROSS-REFERENCE TO RELATED APPLICATIONS

This application claims priority to U.S. provisional patent application No. 62/246,429 filed on Oct. 26, 2015, the entire contents of which is hereby incorporated by reference in its entirety.

### BACKGROUND

Genetic or DNA sequencing is the process of determining the precise order of nucleotides within a DNA molecule. It includes any method or technology that is used to determine the order of the four bases (i.e., adenine, guanine, cytosine, and thymine) in a strand of DNA. The advent of rapid DNA sequencing methods has greatly accelerated biological and medical research and discovery

Traditional approaches have looked to compare a set of genomic data against very large databases of known sets of gene variants, computing the combined probability of desired outcome or efficacy given a set of potential therapeutic options. Most often these therapeutic approaches have included pharmacologic therapy; hence, the domain of pharmacogenetics. A drawback with traditional approaches is that real-world datasets can lead to potential errors in interpretation.

### SUMMARY

Embodiments of the disclosure provide a method and computing system for optimizing medical treatment. The computing system includes an application server comprising a processor and non-transitory computer readable storage medium, and a database configured to store clinical data received from one or more clinical data sources and computational data received from the application server. The processor included in the application server is configured to execute instructions stored in the non-transitory computer readable storage medium to: receive, from the database, the clinical data including genome data and clinical profile data for a plurality of patients, for a first patient in the plurality of patients, generate one or more clusters of patients that have similar characteristics to the first patient, compare different therapeutic options within the one or more clusters of cohorts for treatment of the first patient, and, generate a therapeutic recommendation based on comparing the different therapeutic options, wherein data corresponding to the therapeutic recommendation is stored in the database.

### BRIEF DESCRIPTION OF THE DRAWINGS

FIG. 1 is a schematic diagram illustrating an overview of a system for dynamically generating genomic decision support for individualized medical treatment, in accordance with an embodiment of the disclosure.

FIG. 2 is an exemplary flow diagram that provides steps for optimizing an individual's medical treatment based on a genomic decision support system of FIG. 1, according to some example embodiments.

FIG. 3 is an exemplary flow diagram further illustrating the inputs and outputs of the flow diagram in FIG. 2, according to some example embodiments.

FIG. 4 is an exemplary tabular depiction of data stored in one or more databases for a patient and the comparison against a population set, according to one example embodiment.

### DETAILED DESCRIPTION

Embodiments of the disclosure provide a computing system for optimizing an individual's medical treatment. The computing system includes an application server with a processor and non-transitory computer-readable storage medium. The application server is configured to receive data including clinical rules, genome data, and clinical profiles of patients. The application server may receive these data using secure encrypted protocols, such as HL7 (Health Level Seven). After receiving the data, the application server is further configured to cluster cohorts of similar individuals from the received data and compare different therapeutic options within the cluster of cohorts. After the comparison, the application server provides a therapeutic recommendation for the individual. The computing system further includes a database that is configured to store computational data and the data received from the application server.

Molecular diagnostics and next-generation genomic sequencing represent an opportunity to gather precise genomic data about individuals and aggregate the data into large population-level data sets. Coupled with existing phenotypic data sets that describe the clinical profile of these individuals, these techniques may be used to guide individualized therapeutic decisions, under the general rubric of “precision medicine” as intended to mean therapy personalized to an individual's clinical profile including their specific genome, and specifically similarity between their genome and gene variants that contribute to the outcome and/or risk of any given therapeutic approach. Traditional approaches have looked to compare a set of genomic data against very large databases of known sets of gene variants, computing the combined probability of desired outcome or efficacy given a set of potential therapeutic options. Most often these therapeutic approaches have included pharmacologic therapy; hence, the domain of pharmacogenetics. A drawback with traditional approaches is that real-world datasets can lead to potential errors in interpretation; for example, when not properly adjusted for selection bias.

Embodiments of the disclosure provide methods and systems for optimization of therapeutic outcomes. According to some embodiments, by analyzing molecular genomic sequence data from an individual, relative to a pre-defined knowledge base, as well as dynamically generated analyses from comparison to a set of other individuals and molecular genomic sequence data of those other individuals along with their therapeutic history and clinical outcome, medication selection for optimum therapeutic outcomes is achieved. The system determines likelihoods of the desired clinical outcome and adverse event profile derived from both the predefined knowledge base along with the dynamic analysis of large-scale population data (e.g., 1 million clinical profiles including linked genomes or an appropriate sample size of clinical profiles with linked genomes sufficient for statistically-powered analyses), and provides a set of recommendations and alternatives for a clinician based on the patient's profile. In certain instances, the system devises a therapeutic strategy of explicit absence of medical therapy for the purposes of cohort analysis.

Accordingly, since real-world datasets can lead to potential errors in interpretation when not properly adjusted for selection bias, some embodiments provide techniques to seek out similar populations for comparison matched not only for the clinical profile of a patient, but also the propensity to be assigned to any given therapy. High-dimensional propensity score matching, for example, may be applied in large-scale pharmacovigilance techniques in order to help filter out the potential error due to selection bias. As a result, it becomes possible to compare an individual's genome and clinical profile, alongside their therapeutic options, to a larger historical population of individuals with similar profiles, genomes, and the outcomes associated with pursuit of a variety of those potential therapeutic options.

In certain embodiments, since health economic resources are generally finite, it also becomes possible to compare the projected costs of therapy against historical health insurance and pharmacy claims data to compute the projected cost efficacy of various therapeutic approaches, in addition to their relative clinical efficacy.

In yet another embodiment, the system may probabilistically pre-compute the most likely diseases and therapeutic decisions an individual is likely to face in the course of their lifetime, by applying predictive models for each potential clinical condition, e.g., disease as well as therapy likely to beset the individual. The system may then allocate finite computing resources to the most likely clinical scenarios in order to continuously recalculate probabilities of successful outcome and adverse event risk associated a variety of therapeutic strategies. In certain instances, the recalculation can be re-triggered as novel therapies emerge and as the comparison population data expands over time and more historical experience with those novel therapies is gathered in the eligible comparison data set, as well as longer longitudinal outcomes data associated with those therapeutic approaches. In this fashion it may be possible to render to a clinical decision-maker a real-time decision that has already been pre-computed, rather than encumber the user with the delay associated with large-scale computation.

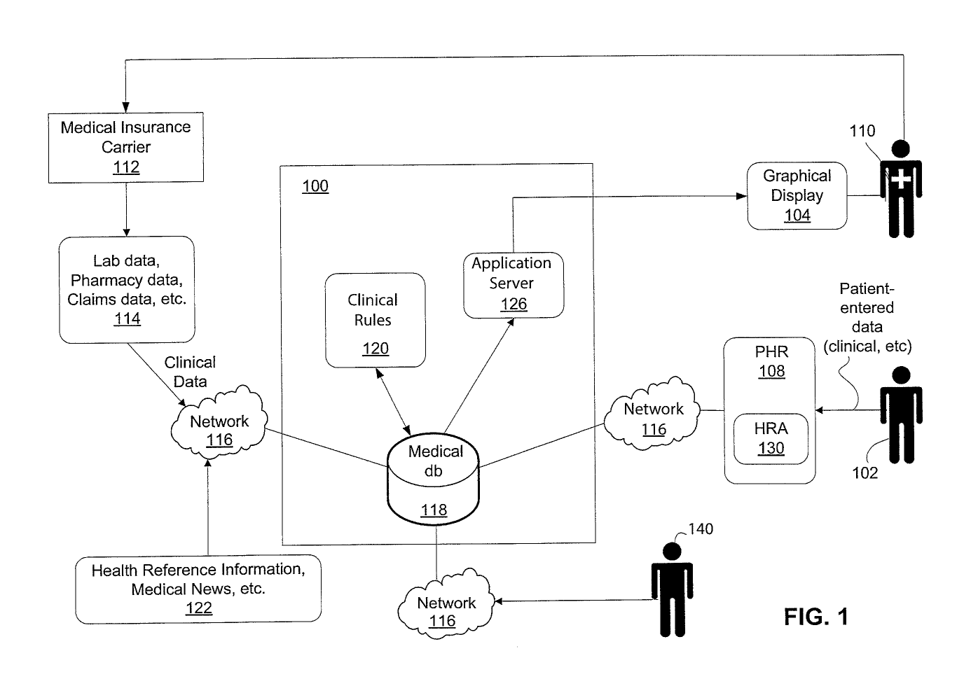

FIG. 1 is a schematic diagram illustrating an overview of a system for dynamically generating genomic decision support for individualized medical treatment, in accordance with an embodiment of the disclosure. In FIG. 1, several entities are provided, including: a health care organization computing device(s) 100 that include a clinical rules 120 module, one or more servers including application server 126, and one or more medical databases 118; a communication network 116; a medical insurance carrier 112; various sources of medical data 114 and 122; client device with a graphical display 104; an online personal health record (PHR) 108 which may include a health risk assessment tool (HRA) 130; a patient 102; a healthcare provider 110; and an interested party 140, which may be a healthcare provider, a patient, or another authorized individual, e.g., a caretaker or family member of the patient.

A health care organization 100 collects and processes a wide spectrum of medical care information relating to a patient 102 in order to dynamically generate genomic decision support for individualized medical treatment and/or generate and deliver customized alerts, including clinical alerts through a graphical display 104 and personalized wellness alerts, directly to the patient 102 via an online interactive personal health record (PHR) 108 or to a party of interest 140, in general. In addition to aggregating patient-specific medical records and alert information, the PHR 108 also solicits the patient's input for entering additional pertinent medical information, tracking of alert follow-up actions and allows the health care organization 100 to track therapeutic outcomes.

A medical insurance carrier 112 collects clinical information originating from medical services claims, performed procedures, pharmacy data, lab results, as well as structured electronic clinical data, e.g. CCD (continuity of care document) in standardized format, and provides it to the health care organization for storage in a medical database. Medical service claims may include diagnostic codes, procedure and revenue codes, medication and pharmacy codes, and laboratory and biomarker results. These different data that may be obtained from medical insurance carrier 112 are designated in FIG. 1 as item 114. The medical database 118 comprises one or more medical data files located on one or more computer readable media, such as a hard disk drive, solid-state storage, a CD-ROM, a flash drive, a tape drive, or the like.

The medical database 118 not only obtains clinical data from medical insurance carrier 112 but also obtains data from other sources. A health care system includes a variety of participants, including doctors, hospitals, insurance carriers, and patients. These participants frequently rely on each other for the information necessary to perform their respective roles because individual care is delivered and paid for in numerous locations by individuals and organizations that are typically unrelated. As a result, a plethora of health care information storage and retrieval systems are required to support the heavy flow of information between these participants related to patient care. The plethora of information may include health reference information, medical news, newly approved therapies and procedures, population set of genomes with linked phenotypes, therapeutic history of individuals in this population set, and the outcomes of those therapies and procedures these individuals. Items 122 and 120 encompass the breath of such information. In some embodiments, genomic data for population sets are stored in research databases at research institutions, commercial entities that help individuals trace heritage and ancestry, or health-related institutions like hospitals. The idea is that information necessary may be collected and stored in medical database 118, but medical database 118 need not store all information necessary for computing at all times.

In some embodiments, large-scale databases of individuals, including their linked genomic data, are likely necessary to represent the probability of rare but significant gene variants that may significantly affect the efficacy or risk related to a given therapy. Similarly, large-scale databases containing a broad set of therapeutic data including pharmacologic therapy as well as medical devices, procedure, psychotherapeutic and other medical therapeutic approaches, offer the opportunity to examine and compare the potential efficacy of multiple pharmacologic as well as non-pharmacologic therapeutic approaches. Also, large-scale databases may also contain the breadth of data to indicate the explicit absence of a clinical event, such as therapy, in the scenarios in which a comparison of doing nothing (for example a strategy termed “watchful waiting”) is compared against other strategies of active intervention and therapy. Therefore, access to these large databases may drastically improve results.

To supplement the clinical data 114 received from the insurance carrier 112, the PHR 108 may allow patient entry of additional pertinent medical information that is likely to be within the realm of patient's knowledge. Exemplary patient-entered data 128 includes additional clinical data, such as patient's family history, use of non-prescription drugs, known allergies, unreported and/or untreated conditions (e.g., chronic low back pain, migraines, etc.), as well as results of self-administered medical tests (e.g., periodic blood pressure and/or blood sugar readings). In some cases, the PHR 108 facilitates the patient's task of creating a complete health record by automatically populating the data fields corresponding to the information derived from the medical claims, pharmacy data and lab result-based clinical data 114. In one embodiment, patient-entered data 128 also includes non-clinical data, such as upcoming doctor's appointments. In some embodiments, the PHR 108 gathers at least some of the patient-entered data 128 via a health risk assessment tool (HRA) 130 that requests information regarding lifestyle behaviors, family history, known chronic conditions (e.g., chronic back pain, migraines) and other medical data, to flag individuals at risk for one or more predetermined medical conditions (e.g., cancer, heart disease, diabetes, risk of stroke) pursuant to the processing by an application server 126. In certain instances, the HRA 130 presents the patient 102 with questions that are relevant to his or her medical history and currently presented conditions. The risk assessment logic branches dynamically to relevant and/or critical questions, thereby saving the patient time and providing targeted results. The data entered by the patient 102 into the HRA 130 also populates the corresponding data fields within other areas of PHR 108.

Embodiments of the disclosure provide one or more servers including an application server 126. For simplicity in language, the one or more servers will be aggregated and referred to as application server 126. The application server 126 comprises one or more network interfaces, one or more processors, one or more storage elements, memory, and one or more interface devices for inputting and outputting of data.

In certain instances, the application server 126 contains a data receiver engine that utilizes the one or more network interfaces and/or the one or more interface devices to receive health data using secure encrypted protocols. The application server 126 operates closely with the medical database 118. The application server 126 utilizes the medical database 118 to store the received health data. The application server 126 may also have data input adapters to receive, decrypt, and decompress genome and clinical profile data about patients. The application server 126 may also have data security engines to encrypt large-scale data at rest and permit encrypted queries without decryption of the data, as a means to secure the large data set even upon breach of perimeter defenses.

Furthermore, in some embodiments, the application server 126 is configured to interface with a knowledge-driven decision support mechanism including a knowledge database and clinical rules 120. The application server 126 may comprise an analytic engine including clinical phenotype and sequence similarity search engines for the purpose of clustering cohorts of similar individuals and comparing different therapeutic options. The application server 126 may further include a predictive modeling apparatus to incorporate both static and also to compute and then incorporate dynamically-generated predictive models in order to support prioritization of pre-computation of potential clinical scenarios an individual may face.

The application server 126 may be configured to perform load-balancing functions to assess the computational capacity of the computing environment and prioritize the appropriate computations including pre-calculation of potential future clinical decisions, as well as ad hoc requests and re-prioritizations for scenarios not predicted or already calculated to deliver near real-time recommendations.

In certain embodiments, the application server 126 may include application programming interface to permit software-to-software machine interoperability between the system and other software systems, particularly Electronic Health Record (EHR) systems with computerized physician order entry, as well as utilization management (UM) systems used by health insurers and other payors to adjudicate prior certification, pre-authorization, concurrent review, retrospective review and other insurance adjudication decisions. Furthermore, the application server 126 may be extended to host a user interface and software application to render the therapeutic options, associated probabilities of positive and negative outcomes, composite risk and benefit, and recommendations to the users. The software systems provided in the application server may implement messaging functionality to securely send resultant clinical decisions over standardized secure health transport protocols to clinical endpoints.

In some embodiments, the application server 126 may include systemic diagnostic mechanism to apprise the users and system administrators as to the recent and historical performance of the recommendations with regards to concordance between recommendation and actual decision, as well as the subsequent clinical and economic outcomes of the recommended decision as well as the actual decision made.

The medical database 118 is configured to receive clinical profile and linked genome databases at individual-level detail. Electronic data obtained through network 116 arrive, e.g., clinical trial participant databases including linked genomes, health insurance claims data, genome data from insured members, and are added to the medical database 118.

In some embodiments, genome data is compressed against reference genomes (e.g., Camrbidge Reference Sequence), e.g., Chem/Weissman, Fritz, LW-FQZip/Zhang, quip/Jones, quip-a, DSRC, DSRC2, Fqzcomp, etc. The genome data may be decompressed on demand, while the compressed delta describing the variations between the individuals' genome and reference genome are preserved and added to the medical database 118 including the computed similarity distance for the purposes of further indexing in the aims of accelerating the need for eventual genome similarity search. In some embodiments where generalized compression (e.g., bzip2) is used, the sequence is decompressed in a secure environment and recompressed in reference-based compression scheme optimized for computing overhead, time and storage space, and then similarity distance computed and indexed for the purpose of eventual similarity search.

The application server 126 may utilize clinical rules 120 to implement a knowledge-driven decision support rules engine and may apply similarity searches of known gene variants against the patient 102's data, highlighting any known variants with a contribution toward a known pharmacogenetic effect (e.g., drug metabolism variant) as well as variants that may act in combination to produce a given effect.

In certain embodiments of the disclosure, a method of optimizing an individual's treatment using the system provided in FIG. 1 begins with a similarity search that is performed to define a cohort of similar individuals on the basis of diseases and conditions and genome data availability. A grouper algorithm may be applied to automatically generate disease and clinical attribute groupings amongst the individuals in the comparison data set. A multi-dimensional vector is generated for each individual's clinical profile. In some embodiments, clustering and nearest-neighbor algorithms may then be applied to these high-dimensional data, such as k-means clustering with clusters with radii containing the individual in question, including greedy clustering, Lloyd's algorithm in the case of k-means clustering, and c-approximate r-Near Neighbor algorithms. High-dimensional distance indexing may be performed on a continuous basis for each individual clinical profile vector to permit more rapid searching for similar phenotypes, thereby permitting distance computations to be re-used to build the index, such that subsequent similarity queries may be performed with fewer distance computations than an exhaustive, sequential scan of the entire dataset. In certain embodiments, by reducing the entire dataset to a dataset of interest, the vectors may be truncated to the conditions with most potential impact on the relevant outcome, in the case of need to accelerate computation or constrained computing resources at the time the output is requested by the user.

From this similar cohort, then, sub-groups are computed on the basis of historical therapeutic options pursued and specific therapeutic similarity (e.g., sets of individuals who took the same medication for the same therapy) using similarity search methods as above but restricted to therapeutic similarity. From these sub-groups, probabilities of a library of outcomes is computed including the specific goal outcomes of the therapeutic decision (e.g., eradication of an infection; destruction of a tumor; prevention of vision loss due to glaucoma) as well as non-prespecified outcomes and adverse event rates. Given the large number of hypotheses tested, as in similar Genome Wide Association Studies (GWAS), statistical significance criteria are significantly more rigorous with a predefined threshold, e.g., a threshold of less than 5×10⁻⁸. Odds ratio probabilities are then computed for the variants represented in the cohort and subgroups, and a composite probability of outcome is then summed and computed for each therapeutic option. The statistical difference (or non-difference) between each therapeutic option, including explicitly doing nothing, is then calculated on a pairwise basis for each head-to-head comparison and then groupwise 1:n comparison, to assess whether an individual therapeutic approach is statistically superior or inferior to any other approach or else the group of alternate approaches.

In some embodiments, a cost perspective is adopted, and the cohorts are then further calculated for the likely costs associated with each therapeutic strategy including the direct costs of therapy as well as the projected downstream costs or savings associated with each therapeutic option.

In some embodiments, to permit more rapid assessment in the case of point-of-care inquiries as well as rapid turnaround scenarios such as automated utilization management decisions and guidance for selection of therapy, predictive modeling coupled with pre-computation of recommended therapies for each individual is performed.

The application server 126 may include a predictive modeling apparatus that utilizes unsupervised machine learning genetic algorithms in order to accelerate the assemblage of a large suite of predictive models aimed at the prediction of each of the disease groups and conditions considered in the similarity search, above. Additionally, a predictive model of likelihood of the clinical profile to change (time-to-change) may be generated to compute a most likely interval in which significant new conditions would appear. A “most-likely” projected clinical profile is then generated for the individual, along with the likely therapeutic decisions and options the individual is likely to face in the future. The interval of prediction (e.g. 1 month from now, 12 months from now, 10 years from now) may be determined by the computing capacity available given the number of individuals likely to face a therapeutic decision, and the velocity at which their clinical profile is likely to change.

From this predicted set of clinical profiles and likely therapeutic decisions for the individual, then, the similarity search and historical therapeutic comparison analysis as described above is performed for each individual ideally prior to the time that the analytic results are needed by the end-user or requested via API (application programming interface).

The application server 126 may host the application programming interface and instantiate it to permit other software to provide machine-interoperable requests for a therapeutic decision. Variables may include the patient identifier, set of therapeutic options under consideration, goals of therapy, and optionally specified thresholds for difference in probabilities or absolute probability of a given therapy or set of therapies emerging as superior to other therapies or approaches.

In some embodiments, a user interface may be provided for a user to specify the individual for analysis, therapies under consideration, therapeutic goal, and desired outcome. The user in this case may be a health care professional. The user interface may then display computation results including projected clinical outcomes, adverse event rates, and costs. Additionally, the user interface may display a composite index to assist the user in comparing the options. In some embodiments, these results may further be automatically or manually sent via secure health data transport standards (e.g., Health Information Systems Program or HISP) to clinical endpoints such as other clinicians involved in the care team and care planning of an individual patient. And where possible, a single-best option, if statistically significant, is presented as the highest-priority recommendation.

In yet another embodiment, subsequent to the output being generated and viewed by the user, an additional software process may be triggered to examine the prospective data going forward for the subsequent clinical decision made as well as economic trajectory of the individual as the result of that decision. These prospective data may be aggregated at a system, patient group, and other ad hoc grouping levels to provide depictions of the “compliance” rate with the recommended therapeutic decision, as well as the cost-related trajectory associated with a set of decisions presented by the system.

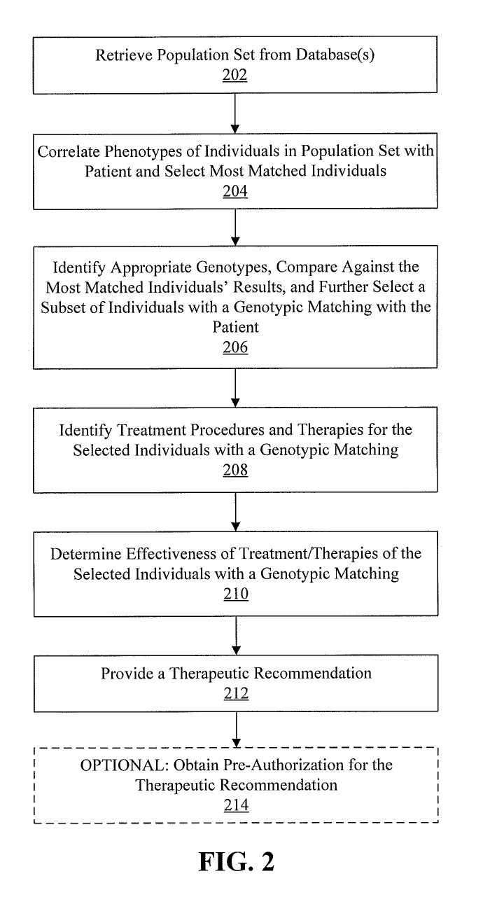

FIG. 2 is an exemplary flow diagram that provides the steps for optimizing an individual's medical treatment based on a genomic decision support system of FIG. 1, according to some embodiments of the disclosure. At step 202, a server, such as the application server 126 in FIG. 1, retrieves a population set from one or more databases, such as database 118 in FIG. 1. This involves application server 126 causing medical database 118 to obtain data from network 116 and clinical rules 120. At step 204, the server compares the phenotypes of individuals in the population set against the phenotypes of the patient, and the individuals matching the patient's phenotypes are selected. The application server 126 uses above mentioned rules and algorithms to determine which individuals within the population set are closely matched phenotypically to the patient, and selects this smaller sample for further analysis.

At step 206, the server compares the genotypes of the smaller sample of individuals against the genotype of the patient for specific genotypes of interest. The individuals that are closely matched with the patient are further selected out of the smaller sample of individuals with matching phenotypes. At step 208, using the new grouping of individuals with genotypes matching that of the patient, the server identifies treatment procedures and therapies. The application server 126 determines which individuals have undergone what treatment or therapy, and at step 210, the server determines the effectiveness of the treatments of the individuals. After comparing the outcomes of the treatments, at step 212, the server provides a therapeutic recommendation.

In some embodiments, at step 214, the server may optionally obtain pre-authorization for performing the therapeutic recommendation. This pre-authorization may be automatically obtained in certain embodiments. For example, the server may interact with the rules engine 120 and a claims processing system to determine that the therapeutic recommendation is proper for a patient having the genetic makeup as the given patient. In some implementations, the pre-authorization request is transmitted to a medical insurance carrier for processing and pre-approval. In some implementations, there is no human being that performs the pre-authorization, i.e., no person is looking at the genetic makeup of the patient; rather, the pre-authorization process simply returns whether the therapeutic recommendation is a match for the patient. Also, in some implementations, therapeutic recommendations can be prioritized based on the patient's genetic makeup. For example, a first therapeutic recommendation may have an 80% chance of success for a patient with the given genetic makeup, whereas a second therapeutic recommendation may have a 70% chance of success for a patient with the given genetic makeup.

In some embodiments, obtaining pre-authorization as described above has certain benefits. For example, an insurance company would never need direct access to an individual's genetic code. Thus a “genetic locker” may be created to secure an individual's genetic information, such as through encryption, so that only authorized users, for example the patient's doctor, may access the genetic code. Additionally, automatically obtaining pre-authorization may minimize and/or eliminate humans being involved in complex matching between payment coverage and the options provided by the algorithms in this patent. In this embodiment, and as described above, algorithms would determine which treatment would be most efficacious for an individual based on the individual's genetic code (steps 202-212). In certain embodiments, multiple recommendations are provided at step 212 with an indication of priority, such as from best to worst. Another algorithm determines whether particular treatments are covered by an individual's insurance. The system may then inform the individual's physician which of the multiple recommendations are covered by the individual's insurance. In an alternative embodiment, all personally identifiable healthcare information is removed from the data. In this embodiment, an individual's doctor would merely receive the results of the treatment matching algorithms. As described below tokenized authentication and other methods may be used to match an individual with the results of the treatment matching algorithms. In certain embodiments, such as in a single payer government system, payment authorization may be provided as described above rather than insurance pre-authorization.

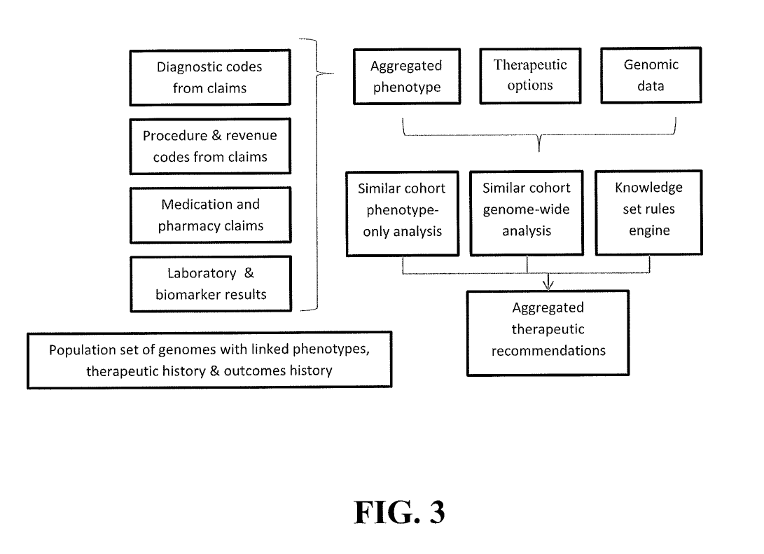

FIG. 3 provides exemplary inputs to the genomic decision support system. Inputs to the system may include diagnostic codes from claims, procedure and revenue codes from claims, medication and pharmacy claims, laboratory and biomarker results, and population set of genomes with linked phenotypes, therapeutic history, and outcomes history. From the inputs to the system, the system prepares the information and packages it in a computational efficient format, allowing for aggregated phenotypes, therapeutic options, and genomic data. Using the computational efficient format, the system determines cohorts with similar phenotypes, then cohorts with similar genome, and then using knowledge set rules, determines medical treatments and therapies. After the analysis, the system provides an aggregated therapeutic recommendation for the patient.

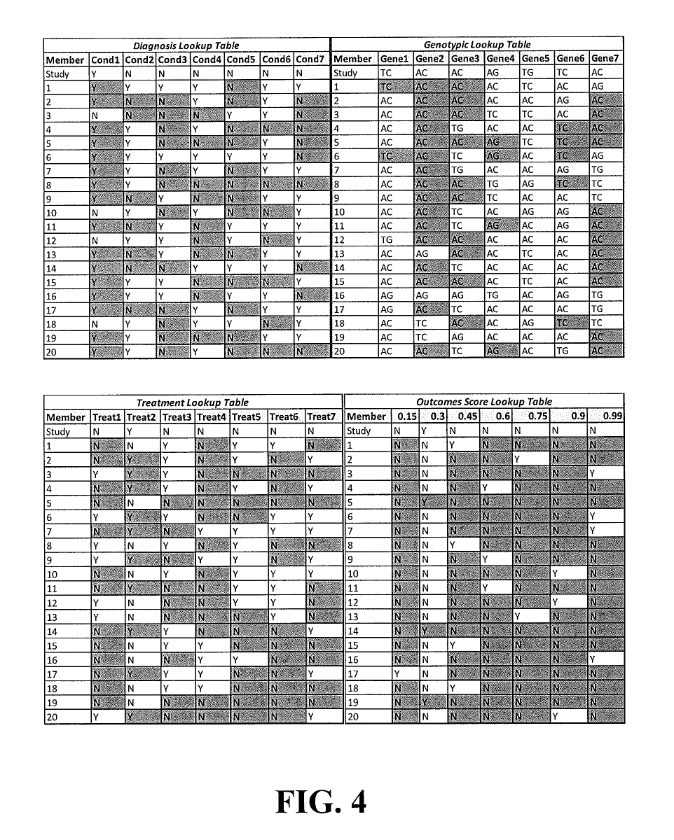

FIG. 4 provides an exemplary embodiment of an efficient computational method using tables. The tables in FIG. 4 are a diagnosis lookup table, a genotypic lookup table, a treatment lookup table, and an outcomes score lookup table. This example provides data for a population of 20 individuals compared against one patient identified as “Study” in the row above Row 1 in the tables in FIG. 4.

In parallel with FIG. 2, at Step 204, the individuals with the same diagnosis with the Study individual are selected. For example, if the healthcare provider was concerned that the Study individual has a Cond1 illness, then the algorithm may choose individuals in rows 1, 2, 4-9, 11, 13-17, and 19-20 as the subset. In certain embodiments, other diagnoses can be important as well, so the subset may be individuals in rows 2, 4, 5, 8, and 20 because they do not match the Study individual in only two other diagnosis while the others do not match in more than two. In certain embodiments, related illnesses are provided more weight in determining the subset; so individuals that suffer from Cond1 and have another illness related to Cond1 may be given more weight when determining the subset. The tabular is display is shown as an example, but the computational explanation already provided is equipped to handle millions of diagnoses.

At Step 206, the genotypes of the subset are compared against genotypes related to Cond1. At this point, the subset chosen is further reduced in size. If Gene3 was found closely associated with Cond1, then the subset of individuals in rows 1, 2, 4-9, 11, 13-17, and 19-20 is reduced to individuals in rows 1, 2, 5, 8, 9, 13, and 15. From these individuals, at step 208, the treatment lookup table is utilized to see which medications or therapies are to be used for Cond1. Each treatment column will have an associated outcomes score lookup table. Only looking at the individuals of interest, the therapy with the best outcome score can be determined based on the narrow subset. Accordingly, after determining a therapy, this therapy may be compared against the Study individual in the Outcomes Score lookup table. If the chosen therapy has a low outcome from the Study previously taking the medication, then another medication may be chosen.

In other exemplary implementations, the data in the tables may be stored in a format that enables quick searches. For example, index searching may be performed if data is stored in a key-value pair format. Then instead of dealing with large tables, smaller data sets can be extracted and searched through much more quickly. Various search algorithms like binary searching may be applied in these cases. An additional advantage to the key-value pair format for storage is that when certain information is not available, then data designating the information is not available is not stored in memory. For example, referring to FIG. 4, if Study never underwent Treat6 therapy under the Treatment Lookup Table, then instead of having an “N” in the table, the data would be nonexistent. The row entry for Study at the moment shows the need to store 7 values corresponding to each treatment. With the key-value method to storage, the row entry may take the form of [Study, {Treat2, “Y”}]. By reducing the amount of data to search against, the computational efficiency of the searches is increased. Sparse tables may be used as well to improve search efficiency.

### EXAMPLE IMPLEMENTATIONS

The following are examples of the dynamically-generated genomic decision support system at work, according to some embodiments of the disclosure.

### Example 1

Patient_0, a 50 year old woman, starts experiencing mild stomach issues and has trouble sleeping, waking up frequently with heartburn-like symptoms. Patient_0 visits her primary care physician, Doctor_0, who diagnoses Patient_0 with a mild case of Cond3. Doctor_0 prescribes 20 mg of Treat6 for an eight (8) week period.

Five years ago, Patient_0 was intrigued by knowing more about her ancestry and decided to pay to have her genome sequenced and stored. Unbeknownst to her at the time, her Gene1 and Gene2 genes each had a mutation on them. Doctor_0 was also unaware of this at the time of prescription.

As Doctor_0 sends the prescription information for Treat6 to Patient_0's pharmacy of choice, immediately that prescription is sent to Patient_0's medical insurance carrier's genomic decision support system. The genomic decision support system is a personalized, n-of-1, service that analyzes Patient_0's genome, identifies the nucleotide pairs on both her Gene1 and Gene2 genes that are especially relevant to her diagnosis and treatment, and examines all members in the medical insurance carrier's database who have matching nucleotide combinations at these loci and have been prescribed a proton pump inhibitor (PPI), the class of medication in which Treat6 resides. The system identifies superior outcomes with all PPIs associated with the reduction of Cond3-related future physician visits and other related medication prescription. The system also identifies, however, that Treat6 is correlated with diarrhea for women between the ages of 45-60 with the Gene2 nucleotide pair “CG” (which Patient_0 has) at a much higher rate than other drugs in the PPI class, such as Treat7.

After the analyses are completed, Patient_0 receives a push notification on her mobile device. In some cases, Patient_0 would receive this notification within three (3) seconds of Doctor_0 prescribing Treat6. The message then alerts Patient_0 that there is a message from the system waiting for her in her secure mailbox related to her latest health system interaction.

The message provided in her secure mailbox may highlight the efficacy of the prescribed drug and provide specific details about other drugs with similar efficacy that may have reduced side effect to Patient_0 according to the genomic analysis. Additionally, the message may be sent to Doctor_0 or prompt Patient_0 to show the message to Doctor_0 in case Doctor_0 may want to change the prescription.

### Example 2

Patient_1, a 62 year old woman and breast cancer survivor, visits Doctor_1 for an annual physical checkup. As part of taking her routine history and physical examination, Doctor_1 learns that Patient_1's younger sister has just been diagnosed with ovarian cancer. Patient_1's examination is unremarkable and she appears to be in fine health. However, Doctor_1 is concerned about the familial linkage to ovarian cancer, especially with Patient_1's prior breast cancer, and decides to order a BRCA1 and BRCA2 genetic test for Patient_1 to better assess if there is an inherited risk Patient_1 has for both breast and ovarian cancer.

Last year, Patient_1 was intrigued by knowing more about her ancestry and decided to pay to have her genome sequenced and stored. Patient_1 has since forgotten from the report she received at that time the fact that she possesses a mutation on both her BRCA1 and BRCA2 genes. This information was also never passed along to Doctor_1.

As Doctor_1's office requests authorization for the BRCA1 and BRCA2 test from a gene sequencing company, immediately that request is also sent to a genomic decision support system that has obtained Patient_1's information indicating that the BRCA1 and BRCA2 genes have already been analyzed. The genomic decision support system finds its target and instantaneously returns a match. Doctor_1's office and the gene sequencing company are both informed of this match and the request for the BRCA1 and BRCA2 testing is automatically denied. Additionally, the genomic decision support system sends Doctor_1 the results of the BRCA1 and BRCA2 testing within the denial explanation so that Doctor_1 can use this information to care for Patient_1.

Doctor_1's office reaches out to Patient_1 to schedule a follow-up visit, where Doctor_1 informs Patient_1 of her inherited risk of breast and ovarian cancer and educates Patient_1 on ways to watch for signs. Upon self-examination, if Patient_1 should feel any protrusion in her breast or experience frequent urination, trouble eating, pelvic or abdominal pain, and or bloating, she is instructed to call Doctor_1 immediately and schedule an appointment. Patient_1, while concerned, is more confident that she and Doctor_1 now have a plan to identify risk. Doctor_1 also recommends Patient_1 speak with a genetic counselor to better understand other alternatives care, such as preventative surgery.

Patient_1 is further comforted because before her follow-up visit she has received news of why her test was denied by her medical insurance carrier. Patient_1 received a push notification on her mobile device within a few seconds of Doctor l′ office requesting the BRCA1 and BRCA2 tests. The mobile device alerted her that there was a new message from the genomic decision support system waiting for her in her secure mailbox related to her latest health system interaction.

The message provided to Patient_1 may include actions taken by Doctor_1's office regarding the genetic test and then provide that the reason the genetic test was denied was because Patient_1's genetic information was available through other channels and that the results from the previous test was sent to Doctor_1's office. The message may further provide how much money Patient_1 has saved by not re-doing the genetic test.

### Other Exemplary Configurations of the Support System

In some embodiments, the genomic decision support system may require acquisition and sequencing for different reasons. The sequencing may be performed in response to health concerns, standard procedure at birth to predict diseases, genetic counseling, ancestry, or plain curiosity. Once the genetic sequencing is performed, the data remains at a secure database that may be accessed by authorized health care organizations for implementing the genomic decision support system disclosed herein.

In some embodiments, storage, encryption, and compression may be achieved on a mobile device, specialized hardware, a field programmable gate array (FPGA), or application specific integrated circuits (ASIC) that store, encrypt, and allow access. Additionally, distributed storage may also be incorporated to provide for additional security. In yet another embodiment, reference-based genome compression algorithm may be utilized.

In some embodiments, access and matching may be aided or tuned by record locator services to know exactly where a patient's genome is stored. Tokenized authentication may be used for further security in accessing data. A consent process may be implemented before sharing an individual's genome. Other privacy controls may be adopted as well with API's to allow authorized users to set these controls. Additionally, data visualization and interface designs may be incorporated to enhance usability. Furthermore, biometric authentication may be adopted.

In some embodiments, computing would be enhanced by the system since it will allow clinically searching for similar humans based on humans with similar genomic patterns.

In addition to aforementioned examples, there are many uses for such a system. Certain embodiments of the disclosure enable the creation of a genomic record location service. Other embodiments enable personalized clinical decision support where a method of offering personalized health treatments at a point of care is realized. In certain instances, real time analysis to direct care (n-of-1 medical policy) is provided. The algorithm recommends a specific therapy based on matching a single human's genome to the body of evidence and other humans' genomes. Additionally, automated authorization of specific treatments or therapies based on genomic data is possible. A rule may be made that if the cost for one SNIP for a specific procedure is greater than the full genome sequence, then require full sequence and store it for future use. The storage algorithm may be specified as well.

Some embodiments of the disclosure provide a system that allows consumers to view their most effective, least toxic treatment option based on their genome since database query is based on creating a personalized recommendation by comparing consumer genome against other genomes, diagnoses, treatments, and outcomes thereby providing scores for efficacy and toxicity. In certain instances, consumer-driven risks, side effects, benefits, and alternatives become more apparent. For example, consumer education and preferences, about, say, side effects of a drug, may inform therapy choice (e.g., some proton pump inhibitors give the consumer diarrhea).

Some embodiments of the disclosure further enable useful interventions. For example, safety is enhanced because based on genome, a dangerous therapy may be eliminated. Efficacy may be improved because based on genome, an ineffective therapy may be avoided. Comparative effectiveness may be more apparent because based on genome the best therapy is more apparent in comparison to other therapies. Coverage alternatives may be identified where an effective medication or treatment may not be covered by a medical insurance carrier.

In certain embodiments, clinically similar human search is enhanced by creating a “similarity index” determined from comparing a customer's genome against other genomes, diagnoses, treatments, and outcomes. These may be used to better focus clinical trials recruitment, transplant donor searches, cohort studies, prenatal counseling, and/or other clinical uses requiring analysis of degrees of similarity between individuals.

Certain embodiments eliminate duplicate sequencing costs. Information provided by the system may further be used for prognostic and predictive indicators that provide information related to how long an individual will live and what will medical care and/or disabilities cost. The system may further enable determination of disease and condition risk and what sorts of medication an individual may take prophylactically for prevention. For example, metformin may be taken by pre-diabetics to prevent diabetes when identified as a high risk for diabetes.

Embodiments of the disclosure may further provide data visualization for lay person use to understand implications. A stunningly unique design that would be unmistakable. Additionally, certain embodiments provide and enhance research and development (R&D) for pharma/biologic manufacturers who utilize the outcomes based data.

Some embodiments enhance several hardware devices. For example, encrypted storage and retrieval may require specialized storage devices or enterprise storage solutions. The network may need to utilize a router could encrypt and/or decrypt genomic data in hardware in order to distribute computing. Additionally, wearable electronics like smart watches and smart bands coupled with certain embodiments may enhance user experience. Some embodiments further provide smart genome onto member identification cards.

Embodiments of the disclosure may further influence a national-level medical policy for countries, and may be utilized to provide biometric identity authentication.

For situations in which the systems discussed here collect personal information about users, or may make use of personal information, the users may be provided with an opportunity to control whether programs or features collect personal information (e.g., genomic information), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computing system for optimizing medical treatment, comprising:
an application server comprising a processor and non-transitory computer readable storage medium; and
a database, configured to store clinical data received from one or more clinical data sources and computational data received from the application server;
wherein the processor included in the application server is configured to execute instructions stored in the non-transitory computer readable storage medium to:
receive, from the database, the clinical data including genome data and clinical profile data for a plurality of patients,
for a first patient in the plurality of patients, generate one or more clusters of patients that have similar characteristics to the first patient,
compare different therapeutic options within the one or more clusters of cohorts for treatment of the first patient, and
generate a therapeutic recommendation based on comparing the different therapeutic options, wherein data corresponding to the therapeutic recommendation is stored in the database.

2. The computing system of claim 1, wherein the processor is further configured to obtain pre-authorization of the therapeutic recommendation based on the genome data and clinical profile data of the first patient.

3. The computing system of claim 1, wherein generating the one or more clusters of patients that have similar characteristics to the first patient comprises one or more of:
grouping patients that have one or more medical conditions in common with the first patient;
grouping patients that have one or more genes in common with the first patient;
grouping patients that have had one or more medical treatments in common with the first patient; and
grouping patients that have had one or more clinical outcomes in common with the first patient.

4. The computing system of claim 1, wherein the clinical profile data comprises one or more of diagnostic codes from claims, procedure and revenue codes from claims, medication and pharmacy claims, and laboratory results.

5. The computing system of claim 1, wherein the genome data comprises a population set of genomes with linked phenotypes.

6. The computing system of claim 1, wherein generating one or more clusters of patients comprises generating disease and clinical attribute groupings among the plurality of patients.

7. The computing system of claim 1, wherein one or more clinical data sources comprise one or more of a medical insurance carrier and one or more pharmacies.

8. A method, comprising:
receiving, at an application server comprising a processor, clinical data including genome data and clinical profile data for a plurality of patients;
for a first patient in the plurality of patients, generating, by the application server, one or more clusters of patients that have similar characteristics to the first patient;
comparing, by the application server, different therapeutic options within the one or more clusters of cohorts for treatment of the first patient;
generating, by the application server, a therapeutic recommendation based on comparing the different therapeutic options; and
storing, by the application server, data corresponding to the therapeutic recommendation in the database.

9. The method of claim 8, further comprising obtaining pre-authorization of the therapeutic recommendation based on the genome data and clinical profile data of the first patient.

10. The method of claim 8, wherein generating the one or more clusters of patients that have similar characteristics to the first patient comprises one or more of:
grouping patients that have one or more medical conditions in common with the first patient;
grouping patients that have one or more genes in common with the first patient;
grouping patients that have had one or more medical treatments in common with the first patient; and
grouping patients that have had one or more clinical outcomes in common with the first patient.

11. The method of claim 8, wherein the clinical profile data comprises one or more of diagnostic codes from claims, procedure and revenue codes from claims, medication and pharmacy claims, and laboratory results.

12. The method of claim 8, wherein the genome data comprises a population set of genomes with linked phenotypes.

13. The method of claim 8, wherein generating one or more clusters of patients comprises generating disease and clinical attribute groupings among the plurality of patients.

14. The method of claim 8, wherein one or more clinical data sources comprise one or more of a medical insurance carrier and one or more pharmacies.

15. A non-transitory computer-readable storage medium storing instructions that, when executed by a processor, cause a computing device to perform the steps of:
receiving, at an application server comprising a processor, clinical data including genome data and clinical profile data for a plurality of patients;
for a first patient in the plurality of patients, generating, by the application server, one or more clusters of patients that have similar characteristics to the first patient;
comparing, by the application server, different therapeutic options within the one or more clusters of cohorts for treatment of the first patient;
generating, by the application server, a therapeutic recommendation based on comparing the different therapeutic options; and
storing, by the application server, data corresponding to the therapeutic recommendation in the database.

16. The computer-readable storage medium of claim 15, wherein the computing device is further configured to obtain pre-authorization of the therapeutic recommendation based on the genome data and clinical profile data of the first patient.

17. The computer-readable storage medium of claim 15, wherein generating the one or more clusters of patients that have similar characteristics to the first patient comprises one or more of:
grouping patients that have one or more medical conditions in common with the first patient;
grouping patients that have one or more genes in common with the first patient;
grouping patients that have had one or more medical treatments in common with the first patient; and
grouping patients that have had one or more clinical outcomes in common with the first patient.

18. The computer-readable storage medium of claim 15, wherein the clinical profile data comprises one or more of diagnostic codes from claims, procedure and revenue codes from claims, medication and pharmacy claims, and laboratory results.

19. The computer-readable storage medium of claim 15, wherein the genome data comprises a population set of genomes with linked phenotypes.

20. The computer-readable storage medium of claim 15, wherein generating one or more clusters of patients comprises generating disease and clinical attribute groupings among the plurality of patients.
